(19) United States
(12) Patent Application Publication
(10) Pub. No.: US 2023/0163661 A1
(43) Pub. Date: May 25, 2023

(54) BLOWER MOTOR

(71) Applicant: Dongguan Kede Precision Manufacturing Co., Ltd., Dongguan (CN)

(72) Inventor: YOUWEI TANG, Dongguan (CN)

(21) Appl. No.: 17/902,699

(22) Filed: Sep. 2, 2022

(30) Foreign Application Priority Data
Nov. 23, 2021 (CN) 202122876525X

(51) Int. Cl. H02K 5/173; F04D 19/00; F04D 29/54; F04D 25/06; F04D 29/20; F04D 29/64; F04D 29/10; H02K 5/24; F04D 29/66

(52) U.S. Cl. CPC H02K 5/1732; F04D 19/002; F04D 29/545; F04D 25/0693; F04D 29/20; F04D 29/644; F04D 29/102; H02K 5/24; F04D 29/668

(57) ABSTRACT

A blower motor is provided and includes a support assembly provided with a first stop step surface, a stator assembly disposed in the support assembly, a rotor assembly disposed in the stator assembly and an end cover disposed on the stator assembly and abutted against the support assembly and provided with a second stop step surface. The rotor assembly includes a rotating shaft and two ends of the rotating shaft are respectively provided with a first bearing and a second bearing. A resilient gasket is provided on one of the first stop step surface and the second stop step surface. The bearings are positioned by springs and cooperate with the resilient gasket to apply a tightening force to the bearings, which can reduce clearances in the bearings and effectively prevent balls in the bearings from making noise under a high-frequency vibration.

### TECHNICAL FIELD

The disclosure relates to a field of air duct motor technologies, and more particularly to a blower motor.

### BACKGROUND

Air duct motors are permanent magnet brushed direct current (BDC) motors. The BDC motor is a rotating motor that contains an electrical brush converting direct current (DC) energy into mechanical energy (i.e., the BDC motor is taken as a DC motor), or contains an electrical brush converting mechanical energy into DC energy (i.e., the BDC motor is taken as a DC generator).

As there are clearances in bearings of a motor, they can be divided into a radial clearance and an axial clearance according to directions of movement. A maximum amount of activity along a radial direction is called the radial clearance, and a maximum amount of activity along an axial direction is called the axial clearance. Generally speaking, the larger the radial clearance is, the larger the axial clearance is, and vice versa. A rotor will receive an axial electromagnetic force during operation of the motor, so as to generate an axial vibration and make noise.

### SUMMARY

The disclosure aims to provide a blower motor, so as to solve problems proposed in the above background.

In order to achieve the above purposes, a technical solution of the disclosure is as follows. A blower motor is provided, including: a support assembly, a stator assembly, a rotor assembly and an end cover; the stator assembly is disposed in the support assembly, the rotor assembly is disposed in the stator assembly, the end cover is disposed on the stator assembly and abutted against the support assembly; the rotor assembly is provided with a rotating shaft, and two ends of the rotating shaft are provided with a first bearing and a second bearing; the support assembly is provided with a first stop step surface, the end cover is provided with a second stop step surface; a resilient gasket is disposed on one of the first stop step surface and the second stop step surface; the first stop step surface indirectly applies a front tightening force F on an outer ring of the first bearing through the resilient gasket or directly applies the front tightening force F on the outer ring of the first bearing; and the second stop step surface directly applies a back tightening force F′ on an outer ring of the second bearing or indirectly applies the back tightening force F′ on the outer ring of the second bearing through the resilient gasket.

In an illustrated embodiment of the disclosure, the support assembly is provided with a tubular outer shell and an inner shell coaxial with the outer shell. An air duct is provided between the inner shell and the outer shell, and an air inlet and an air outlet which are communicated with the air duct are respectively disposed on front and back of the outer shell. An installation cavity is provided in the inner shell, and first and second supporting parts which are communicated with the installation cavity are respectively disposed on front and back of the inner shell. A first bearing groove and a first rotating shaft protrusion hole are provided in the first supporting part. The first stop step surface is provided between the first bearing groove and the first rotating shaft protrusion hole, and the first bearing is disposed in the first bearing groove. The end cover is installed on the stator assembly and abutted against the second supporting part, a second bearing groove and a second rotating shaft protrusion hole are provided in the end cover. The second stop step surface is provided between the second bearing groove and the second rotating shaft protrusion hole, and the second bearing is disposed in the second bearing groove. The rotating shaft passes through the first rotating shaft protrusion hole, the first bearing, the second bearing, the resilient gasket and the second rotating shaft protrusion hole successively from the air inlet to the air outlet. Or the rotating shaft passes through the first rotating shaft protrusion hole, the resilient gasket, the first bearing, the second bearing and the second rotating shaft protrusion hole successively from the air inlet to the air outlet.

In an illustrated embodiment of the disclosure, an end of the rotating shaft passes through the first rotating shaft protrusion hole and extends out of the inner shell, and is connected with a fan blade on the air inlet by a screw.

In an illustrated embodiment of the disclosure, a plurality of holes are symmetrically and evenly provided on the end cover around a center of the second rotating shaft protrusion hole and the plurality of holes are provided for insertion needles to pass through. Ends of the insertion needles extend through the plurality of holes and are welded with a printed circuit board (PCB). Other ends of the insertion needles are disposed in insertion needle sheaths respectively and a portion welded with a copper wire of each of the insertion needles is sheathed in an insulating sheath.

In an illustrated embodiment of the disclosure, a side of the PCB is fixedly provided with a socket.

In an illustrated embodiment of the disclosure, the rotating shaft is provided with three spring grooves and the three spring grooves are respectively provided with a first spring (also referred to a first circlip), a second spring (also referred to a second circlip) and a third spring (also referred to a third circlip).

In an illustrated embodiment of the disclosure, the first spring and the second spring are respectively provided on two sides of the first bearing or the second bearing.

In an illustrated embodiment of the disclosure, the resilient gasket is a wave-shaped spring sheet, the wave-shaped spring sheet is provided with an upper end surface and a lower end surface, the upper end surface and the lower end surface are curved surfaces, and the wave-shaped spring sheet is made of a metal material.

In an illustrated embodiment of the disclosure, the resilient gasket is a silicone rubber gasket, the silicone rubber gasket is provided with an upper end surface and a lower end surface, the upper end surface and the lower end surface are flat surfaces, and the silicone rubber gasket is made of resilient plastic.

Compared with the related art, the disclosure has effective effect as follows.

It is convenient to drive the fan blade to rotate through the rotating shaft by assembling the rotating shaft, the second spring, the fan blade and the screw with other components, as well as fixing the fan blade at one end of the rotating shaft. It is convenient for the screw to fix the fan blade by connecting the screw to a screw thread, which is disposed on one side of the rotating shaft. The fan blade is stable and not loose when rotating by locking with the screw, setting force steps, and installing the first spring on the rotating shaft, and making locking direction of the screw opposite to rotating direction of the fan blade.

It is convenient for the first bearing and the second bearing to rotate by setting the resilient gasket and the springs and fixedly installing the first bearing and the second bearing on two ends of the rotating shaft. And it is convenient for the springs to position the bearings by installing the springs on an inner side of the first bearing and the second bearing. The resilient gasket is fixedly installed on another side of the first bearing or the second bearing, so as to apply the tightening force on the bearings, reduce clearances in the bearings, and effectively prevent balls in the bearings from making noise under high-frequency vibration.

It is convenient for the insertion needles to be fixedly installed by setting the stator assembly, the insertion needles, the insertion needle sheaths and other components, and fixedly installing the insertion needles on one side of the stator assembly. The insertion needles are sheathed into the insertion needle sheaths, so that the insertion needles can be insulated and protected. Using the insulating sheaths to protect the insertion needles can perform good insulation and fix the PCB. The insulating sheaths are made of engineering insulating materials by injection molding to form an insulating barrier among the insertion needles, the outer shell and the end cover, which greatly reduces poor insulation and withstand voltage. Moreover, the integrated molding has a dimensional stability, so the PCB can be firmly installed.

The fan blade and the rotating shaft of the disclosure are screwed by the screw extending through the rotating shaft hole and screwing with the screw thread hole. Two parallel surfaces of a nut of the screw are matched with a groove of the screw, so as to ensure that the fan blade cannot loosen in axial direction during high-speed operation and a relative axis of the fan blade cannot slip in circumferential direction.

### BRIEF DESCRIPTION OF DRAWINGS

FIG. 1 is a sectional diagram of a blower motor according to an embodiment of the disclosure.

FIG. 2 is an enlarged diagram of part A in FIG. 1 of the blower motor according to an embodiment of the disclosure.

FIG. 3 is an exploded diagram of the blower motor according to an embodiment of the disclosure.

FIG. 4 is a schematic structural diagram of a support assembly of the blower motor according to an embodiment of the disclosure.

FIG. 5 is a schematic structural diagram of an end cover of the blower motor according to an embodiment of the disclosure.

FIG. 6 is a schematic diagram of an assembly of a rotating shaft, bearings and springs of the blower motor according to an embodiment of the disclosure.

FIG. 7 is a schematic structural diagram of the rotating shaft of the blower motor according to an embodiment of the disclosure.

FIG. 8 is a schematic structural diagram of a resilient gasket of the blower motor according to an embodiment of the disclosure.

FIG. 9 is a schematic diagram of an assembly of insertion needles, insulating sheaths and a printed circuit board of the blower motor according to an embodiment of the disclosure.

### DESCRIPTION OF REFERENCE NUMERALS

1—support assembly; 11—outer shell; 111—air inlet; 112—air outlet; 12—inner shell; 121—installation cavity; 122—first supporting part; 1221—first bearing groove; 1222—first rotating shaft protrusion hole; 1223—first stop step surface; 123—second supporting part; 13—annular air duct; 14—first bearing; 15—second bearing; 161—first spring; 162—second spring; 163—third spring; 17—resilient gasket;

2—stator assembly;

3—rotor assembly; 31—magnetic ring; 32—rotating shaft; 321—spring groove;

4—fan blade; 41—screw;

5—end cover; 51—second bearing groove; 52—second rotating shaft protrusion hole; 53—hole; 54—second stop step surface;

6—socket;

7—printed circuit board (PCB);

8—insertion needle; 81—insertion needle sheath; 82—insulating sheath;

9—insulating frame.

### DETAILED DESCRIPTION OF EMBODIMENTS

Technical solutions of embodiments of the disclosure will be clearly and completely described in combination with the below attached drawings of the disclosure. Apparently, the described embodiments are only some of the embodiments of the disclosure and not all of the embodiments of the disclosure. Based on the embodiments of the disclosure, all other embodiments obtained by those skilled in the art without any creative effort belong to the scope of the protection of the disclosure.

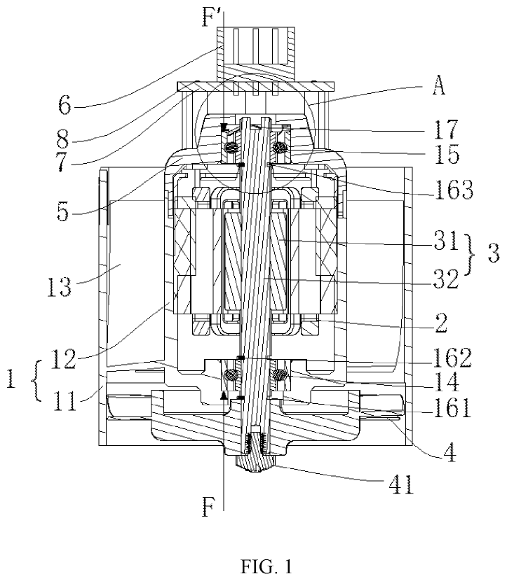

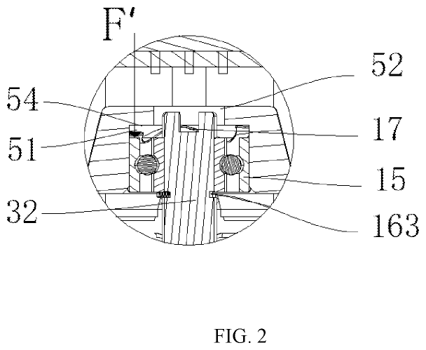

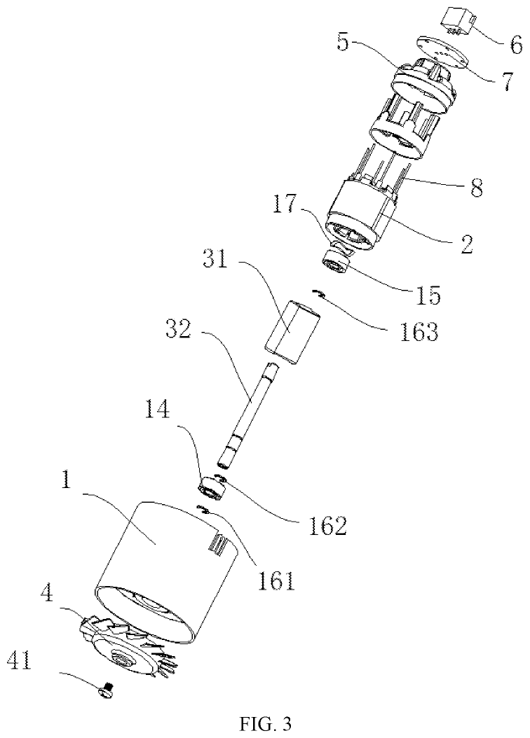

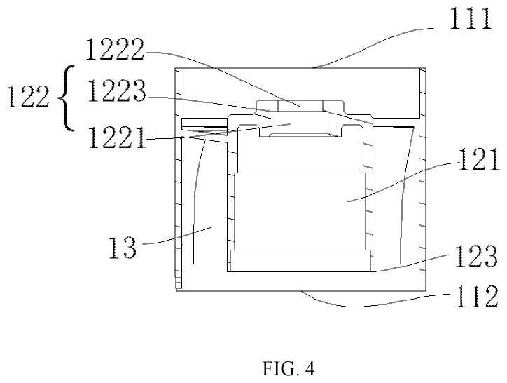

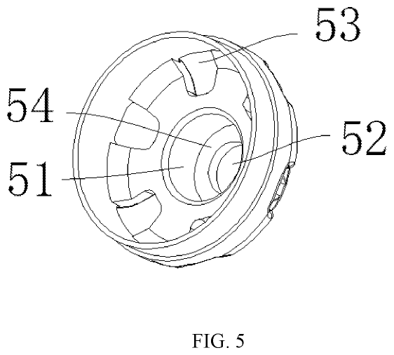

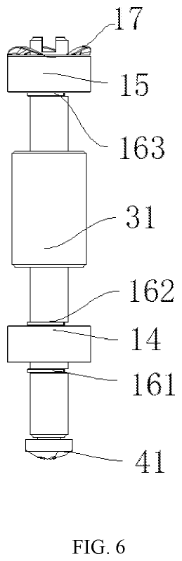

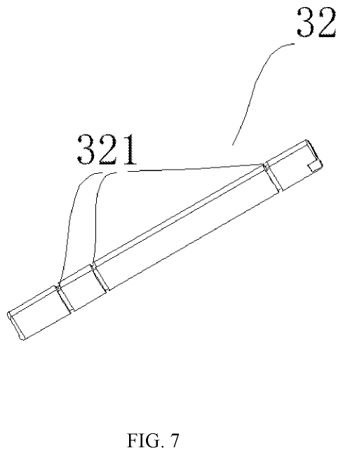

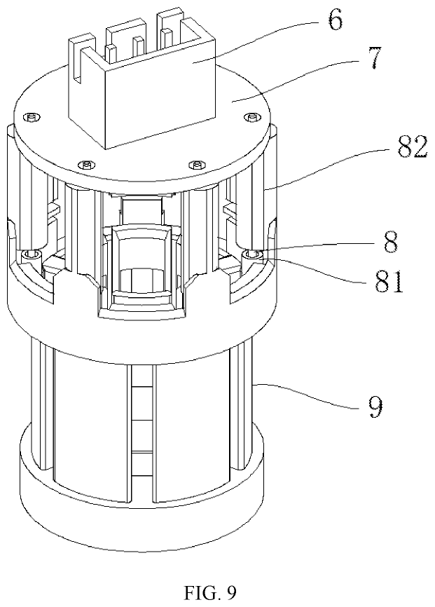

Embodiment 1: as shown in FIG. 1 to FIG. 9, a technical solution of the disclosure is provided. A blower motor includes a support assembly 1, a stator assembly 2, a rotor assembly 3, a fan blade 4 and an end cover 5. The support assembly 1 includes a tubular outer shell 11 and an inner shell 12 coaxial with the outer shell 11. An annular air duct 13 is provided between the inner shell 12 and the outer shell 11. An air inlet 111 and an air outlet 112 communicated with the annular air duct 13 are respectively provided on the front and back of the outer shell 11. An installation cavity 121 is provided in the inner shell 12. A first supporting part 122 and a second supporting part 123 communicated with the installation cavity 121 are respectively disposed on front and back of the inner shell 12. The first supporting part 122 is provided with a first bearing groove 1221 and a first rotating shaft protrusion hole 1222. The first stop step surface 1223 is provided between the first bearing groove 1221 and the first rotating shaft protrusion hole 1222. The first bearing groove 1221 is provided with the first bearing 14 and an outer ring of the first bearing 14 is fitted with the first stop step surface 1223. The first stop step surface 1223 applies a front tightening force F to the outer ring of the first bearing 14. The stator assembly 2 is disposed in the installation cavity 121, and the rotor assembly 3 is disposed in the stator assembly 2. The rotor assembly 3 includes a rotating shaft 32 and a magnetic ring 31. One end of the rotating shaft 32 passes through the first bearing 14 and the first rotating shaft protrusion hole 1222 successively to extend out of the inner shell 12 and is connected to the fan blade 4 through a screw 41 on the air inlet 111, which can ensure the fan blade 4 not loosen axially during high-speed operation and relative axis of the fan blade 4 not slip in circumferential direction. The end cover 5 is installed on the stator assembly 2 and abutted against the second receiving part 123. The end cover 5 is provided with a second bearing groove 51 and a second rotating shaft protrusion hole 52. A second stop step surface 54 is provided between the second bearing groove 51 and the second rotating shaft protrusion hole 52. A second bearing 15 is provided in the second bearing groove 51. A resilient gasket 17 is provided between the second stop step surface 54 and the second bearing 15. A lower end surface of the resilient gasket 17 is fitted with the second stop step surface 54. The second stop step surface 54 applies one back tightening force F′ to the resilient gasket 17, and the resilient gasket 17 applies another back tightening force F′ in a same direction to an outer ring of the second bearing 15. Another end of the rotating shaft 32 passes through the second bearing 15, the resilient gasket 17 and the second rotating shaft protrusion hole 52 successively. A magnetic ring 31 is sleeved on a shaft part of the rotating shaft 32 between the first bearing 14 and the second bearing 15. And the magnetic ring 31, the first bearing 14 and the second bearing 15 are directly fixed to the rotating shaft 32 by interference fit or adhesive or a combination of the interference fit and the adhesive.

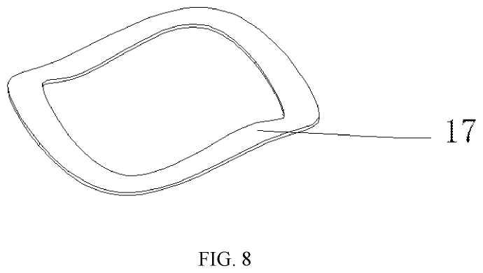

In an illustrated embodiment of the disclosure, the rotating shaft 32 is provided with three spring grooves 321, which are respectively provided with a first spring 161, a second spring 162 and a third spring 163. The three spring grooves 321 respectively limit the first spring 161, the second spring 162 and the third spring 163. The first spring 161 is used to fix the rotating shaft 32 and the fan blade 4, which uses a screw 41 to lock the fan blade 4, sets force step on the fan blade 4. Locking direction of the screw 41 is opposite to rotating direction of the fan blade 4, which can ensure the fan blade 4 stable and not loosen during rotating. The first spring 161 is installed on the rotating shaft 32. The second spring 162 is used to fix the rotating shaft 32 and the first bearing 14. And the third spring 163 is used to fix the rotating shaft 32 and the second bearing 15. The first bearing 14 is positioned by the second spring 162. The second bearing 15 is positioned by the third spring 163 and cooperate with the resilient gasket 17 to apply the tightening force to the second bearing 15. The resilient gasket 17 can adopt a wave-shaped spring sheet or a silicon rubber gasket. When the resilient gasket 17 is a wave-shaped spring sheet (as shown in FIG. 8), the wave-shaped spring sheet has an upper end surface and a lower end surface, both of which are curved surfaces. The upper end surface or the lower end surface is provided with at least two downward protrusions or two upward protrusions, and the wave-shaped spring sheet is made of a metal material. In another embodiment of the disclosure, the resilient gasket 17 is a silicone rubber gasket with an upper end surface and a lower end surface, both of which are flat surfaces, and the silicone rubber gasket is made of resilient plastic.

As there are clearances in the bearings, namely, when the bearings are not installed in a shaft or a bearing box, one of an inner ring and an outer ring of the bearings are fixed, and then a side that bearing clearance is not fixed moves in a radial direction or an axial direction. An amount of activity generated during the movement is the clearance of the bearing. According to directions of the movement, they can be divided into a radial clearance and an axial clearance. A maximum amount of the activity along the radial direction is called the radial clearance, and the maximum amount of the activity along the axial direction is called the axial clearance. Generally speaking, the larger the radial clearance is, the larger the axial clearance is, and vice versa. The rotor will receive an axial electromagnetic force during operation of the motor will receive an axial electromagnetic force during operation of the motor, so as to generate an axial vibration and make noise. In the technical solution of the disclosure, when the first stop step surface 1223 applies a front tightening F on an outer ring of the first bearing 14, the second stop step surface 54 applies one back tightening force F′ on the wave-shaped spring sheet, so that the wave-shaped spring sheet indirectly applies another back tightening force F′ in a same direction on an outer ring of the second bearing 15. The rotating shaft 32 cannot move front and back, so as to eliminate the axial clearance between the first bearing 14 and the second bearing 15 and reduce operation noise of the bearings, thereby effectively preventing balls in the first bearing 14 and the second bearing 15 from making noise under high-frequency vibration.

However, eliminating the axial clearance between the first bearing 14 and the second bearing 15 by providing the first stop step surface 1223 and the second stop step surface 54 may cause the following problems. Due to small size and high precision requirements for production and processing of the blower motor, higher precision is required when processing the first stop step surface 1223 and the second stop step surface 54 in the support assembly 1. Otherwise, it is easy to cause the tightening force failing to achieve a desired effect. When the tightening force is too small, the bearings still have large axial clearances, and an axial force borne by the rotor of the motor cannot be balanced. An axial movement still exists, and low-frequency and periodic buzzing sound reflecting the axial movement will not be reduced. When the tightening force is too large, the axial clearances of the bearings become small or disappear, which affects normal use of the bearings, makes operation of the bearings inflexible. The motor emits a high-frequency scream, causing great noise and even shortening service life of the bearings. In the embodiment of the disclosure, the resilient gasket 17 is provided on the first stop step surface 1223 or the second stop step surface 54. The resilient gasket 17 is the wave-shaped spring sheet. Since the upper end surface and the lower end surface of the wave-shaped spring sheet are curved surfaces, the curved surfaces can maintain an appropriate amount of tightening force applied on the bearings. In addition, in the embodiment of the disclosure, the resilient gasket 17 is the silicone rubber gasket (not shown in FIG). Since the upper end surface and the lower end surface of the silicone rubber gasket are also made of resilient plastic, the tightening force applied on the bearings can also be kept at an appropriate level. By setting the resilient gasket 17 to apply the tightening force on the outer ring of the second bearing 15, the tightening force biases the outer rings of the bearings and at the same time pushes the inner rings of the bearings to make the rotor of the motor generating a corresponding axial displacement. Raceways of the first bearing 14 and the second bearing 15 are completely matched, reducing the axial clearances of the bearings. The axial force borne by the rotor of the motor is exactly balanced, and the axial movement is prevented. Therefore, vibration and noise of the axial direction are relatively small, which effectively prevents the balls in the bearings from making noise under high-frequency vibration. At the same time, requirements for production and processing precision are reduced, which is suitable for promotion and production.

It should be noted that the first spring 161 and the second spring 162 provided on two sides of the first bearing 14 or the second bearing 15 can effectively resist impact force and pulling force of the axial direction, and greatly improve reliability.

When the wind turbine motor is in use, protection measures for charged bodies of the insertion needles are generally poor, which is easy to cause poor performance of insulation and withstand voltage. In an illustrated embodiment of the disclosure, the end cover 5 is made of metal alloy or plastic. A plurality of holes 53 are symmetrically and evenly distributed on the end cover 5 around a center of the second rotating shaft protrusion hole 52. The plurality of holes 53 are used for insertion needles 8 to pass through. When winding, copper wires need to be wound around an outer edge of an insulating frame 9. Heads and ends of the cooper wires (heads and ends of the winding cooper wires, not shown in FIG) are respectively welded on six insertion needles 8. Ends of the six insertion needles 8 need to penetrate into the six holes 53 of the end cover 5 respectively and be welded with a printed circuit board (PCB) 7. A socket 6 is fixedly installed on one side of the PCB 7, other ends of the six insertion needles 8 are inserted into insertion needle sheaths 81 respectively, and a portion welded with copper wire of each of the insertion needles 8 is covered in an insulating sheath 82. The insulating sheaths 82 are injection molded with engineering insulating materials. The insertion needle sheaths 81 form an insulating barrier between the insertion needles 8 and the outer shell 1 and the insulating sheaths 82 between the insertion needles 8 and the end cover 5, which greatly reduces the poor performance of insulation and withstand voltage. The insertion needle sheaths 81 and the insulating frame 9 are integrally formed, with good dimensional stability, which can stably install the PCB 7, or wrap the copper wires and the insertion needles 8 together with adhesive tape to ensure that a creepage distance and the performance of insulation and withstand voltage between the insertion needles 8 and the end cover 5 are qualified. The plurality of holes 53 is provided on the end cover to reduce weight of the installation cover. The plurality of holes 53 are symmetrically and evenly distributed around the center of the second rotating shaft protrusion hole 52, which can maintain a balance of force of the motor, provide ventilation and heat dissipation, prolong the service life of the motor, and ensure a safe electric distance between wire bundles.

Embodiment 2: a difference between the embodiment 2 and the embodiment 1 is that the resilient gasket is provided between the first bearing 14 and the first stop step surface 1223. The second bearing 15 and the second stop step surface 54 do not have the wave-shaped spring sheet. The lower end surface of the wave-shaped spring sheet is fitted with the first stop step surface 1223. The first stop step surface 1223 applies a front tightening force F on the wave-shaped spring sheet, the wave-shaped spring sheet applies the front tightening force F on the outer ring of the first bearing 14 in a same direction, and the second stop step surface 54 applies a back tightening force F′ on the outer ring of the second bearing 15.

Although the embodiments of the disclosure have been displayed and described, it should be understood that those skilled in the art can make various change, modification, replacement and deformation to the embodiments without departing from the principle and spirit of the disclosure. Therefore, the scope of the disclosure is limited by the attached claims and the relative equivalents.

What is claimed is:

1. A blower motor, comprising:
a support assembly, provided with a first stop step surface;
a stator assembly, disposed in the support assembly;
a rotor assembly, disposed in the stator assembly, wherein the rotor assembly comprises a rotating shaft;
an end cover, disposed on the stator assembly and abutted against the support assembly, wherein the end cover is provided with a second stop step surface;
first and second bearings, respectively disposed on two ends of the rotating shaft;
a resilient gasket, disposed on one of the first stop step surface and the second stop step surface;
wherein when the resilient gasket is disposed on the first stop step surface, the first stop step surface is configured to apply one tightening force on an outer ring of the first bearing through the resilient gasket, and the second stop step surface is configured to directly apply another tightening force on an outer ring of the second bearing; and
wherein when the resilient gasket is disposed on the second stop step surface, the first stop step surface is configured to directly apply one tightening force on the outer ring of the first bearing, and the second stop step surface is configured to apply another tightening force on the outer ring of the second bearing through the resilient gasket.

2. The blower motor according to claim 1, wherein the support assembly comprises a tubular outer shell and an inner shell coaxial with the outer shell;
wherein an air duct is provided between the inner shell and the outer shell, and an air inlet and an air outlet which are communicated with the air duct are respectively disposed on front and back of the outer shell;
wherein an installation cavity is provided in the inner shell, and first and second supporting parts which are communicated with the installation cavity are respectively disposed on front and back of the inner shell;
wherein a first bearing groove and a first rotating shaft protrusion hole are provided in the first supporting part, the first stop step surface is provided between the first bearing groove and the first rotating shaft protrusion hole, and the first bearing is disposed in the first bearing groove;
wherein the end cover is provided on the stator assembly and abutted against the second supporting part, and the end cover is provided with a second bearing groove and a second rotating shaft protrusion hole;
wherein the second stop step surface is provided between the second bearing groove and the second rotating shaft protrusion hole, and the second bearing is disposed in the second bearing groove;
wherein when the resilient gasket is disposed on the second stop step surface, the rotating shaft passes through the first rotating shaft protrusion hole, the first bearing, the second bearing, the resilient gasket and the second rotating shaft protrusion hole successively from the air inlet to the air outlet; and
wherein when the resilient gasket is disposed on the first stop step surface, the rotating shaft passes through the first rotating shaft protrusion hole, the resilient gasket, the first bearing, the second bearing and the second rotating shaft protrusion hole successively from the air inlet to the air outlet.

3. The blower motor according to claim 2, wherein an end of the rotating shaft passes through the first rotating shaft protrusion hole and extends out of the inner shell, and is connected with a fan blade on the air inlet by a screw.

4. The blower motor according to claim 2, wherein the end cover is symmetrically and evenly provided with a plurality of holes around a center of the second rotating shaft protrusion hole and the plurality of holes are provided for insertion needles to pass through;
wherein ends of the insertion needles extend through the plurality of holes respectively and are welded with a printed circuit board (PCB); and
wherein other ends of the insertion needles are disposed in insertion needle sheaths respectively, and a portion welded with a copper wire of each of the insertion needles is sheathed in an insulating sheath.

5. The blower motor according to claim 4, wherein a side of the PCB is fixedly provided with a socket.

6. The blower motor according to claim 1, wherein the rotating shaft is provided with three spring grooves and the three spring grooves are respectively provided with a first spring, a second spring and a third spring.

7. The blower motor according to claim 6, wherein the first spring and the second spring are respectively provided on two sides of the first bearing when the resilient gasket is disposed on the second stop step surface; and the first spring and the second spring are respectively provided on two sides of the second bearing when the resilient gasket is disposed on the first stop step surface.

8. The blower motor according to claim 1, wherein the resilient gasket is a wave-shaped spring sheet, the wave-shaped spring sheet is provided with an upper end surface and a lower end surface, the upper end surface and the lower end surface are curved surfaces, and the wave-shaped spring sheet is made of a metal material.

9. The blower motor according to claim 1, wherein the resilient gasket is a silicone rubber gasket, the silicone rubber gasket is provided with an upper end surface and a lower end surface, the upper end surface and the lower end surface are flat surfaces, and the silicone rubber gasket is made of resilient plastic.
